(19) United States
(12) Patent Application Publication
(10) Pub. No.: US 2008/0055371 A1
(43) Pub. Date: Mar. 6, 2008

(54) Ink Tank Interface for an Imaging Apparatus

(76) Inventors: Charles Stanley Aldrich, Nicholasville, KY (US); Christopher Elliot Lingle, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/427,401

(22) Filed: Jun. 29, 2006

(51) Int. Cl. B41J 2/175

(52) U.S. Cl. 347/85

(57) ABSTRACT

An imaging apparatus includes a printhead carrier configured for reciprocating motion along a main scan axis. A printhead assembly is mounted to the printhead carrier. An ink tank is mounted to the printhead assembly. An ink tank interface is formed between the printhead assembly and the ink tank. The ink tank interface is formed by engagement of two angled porous surfaces oriented angularly with respect to a direction of ink flow.

### FIELD OF THE INVENTION

The present invention relates to an imaging apparatus, and, more particularly, to an ink tank interface for an imaging apparatus.

### BACKGROUND OF THE INVENTION

An imaging apparatus, such as an ink jet printer, forms an image on a print medium, such as paper, by applying ink to the print medium. The ink may be contained in one or more replaceable supply cartridges. Examples of such replaceable supply cartridges include a replaceable ink tank and an ink jet printhead cartridge. An ink jet printhead cartridge, for example, includes both an ink tank and an ink jet micro-fluid ejection device, whereas an ink tank does not include the micro-fluid ejection device.

One such ink jet printer mounts a plurality of ink tanks, with each ink tank containing a supply of a particular color of ink, e.g., black, cyan, magenta, and yellow. Each ink tank is mounted to a micro-fluid ejection device that is separately mounted to the printhead carrier, and is commonly referred to as an on-carrier ink tank system. In an on-carrier ink tank system, the ink is transferred from the ink tank to the micro-fluid ejection device through as series of fluid interfaces.

A typical ink tank includes a free ink chamber, an upper felt ink retaining member, and a lower felt ink retaining member. The fluid connection between the ink tank and the printhead is at the contact between the lower felt ink retaining member and a wick. Typically this fluid connection requires significant forces (1 to 2 lbs) and the interface surface is perpendicular to the direction of insertion. The needed interference between the wick and lower felt often results in deformation and lifting of the lower felt. When this occurs, there is a risk that air paths become opened to the communication port with the free ink chamber, and result in low bubble pressure and ink deliver failures. This happens despite that the felts are compressively installed and restrained from above. Any air paths along the side or underneath the lower felt result in inconsistent bubble pressures, and in turn, result in unsatisfactory ink delivery to the printhead.

### SUMMARY OF THE INVENTION

The invention, in one form thereof, is directed to an imaging apparatus, including a printhead carrier configured for reciprocating motion along a main scan axis. A printhead assembly is mounted to the printhead carrier. An ink tank is mounted to the printhead assembly. An ink tank interface is formed between the printhead assembly and the ink tank. The ink tank interface is formed by engagement of two angled porous surfaces oriented angularly with respect to a direction of ink flow.

The invention, in another form thereof, is directed to a removable ink tank configured to be mounted to a printhead assembly installed on an imaging apparatus. The removable ink tank includes a suspended ink chamber having a base, and a plurality of side walls extending away from the base. The base is located along a first plane. The ink chamber has an ink output port formed through the base. A first ink suspension body is positioned in the suspended ink chamber adjacent to the base. The first ink suspension body has a porous ink transfer surface positioned above the ink output port. The porous ink transfer surface is oriented at an acute angle with respect to the first plane of the base.

The invention, in another form thereof, is directed to a printhead assembly configured to be mounted to a printhead carrier of an imaging apparatus. The printhead assembly includes a printhead body. The printhead body has a snout portion forming a base surface. A micro-fluid ejection device is attached to the base surface of the snout portion. A wick retainer is coupled to the printhead body and defines an opening in fluid communication with the micro-fluid ejection device. A wick has a proximal end and a distal end, with the proximal end being inserted into the opening of the wick retainer and the distal end projecting outwardly from the wick retainer. The distal end of the wick has a porous ink receiving surface. The porous ink receiving surface is oriented at an acute angle with respect to a plane of the base surface.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a diagrammatic depiction of an imaging system embodying the present invention.

FIG. 2 is a perspective view of the printhead carrier of FIG. 1, with the printhead assembly and ink tanks uninstalled.

FIG. 3A is a side sectional view of the printhead assembly of FIG. 2 with the ink tank installed.

FIG. 3B is magnified portion of the side sectional view of FIG. 3A, illustrating the forces involved in the engagement of the angled porous ink receiving surface of the wick with the angled porous ink transfer surface of the lower ink suspension body.

FIG. 4 is a perspective view of the angled wick and wick retainer in accordance with an aspect of the present invention.

FIG. 5 is a side sectional view of an uninstalled ink tank including the angled porous ink transfer surface of the lower ink suspension body in accordance with an aspect of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

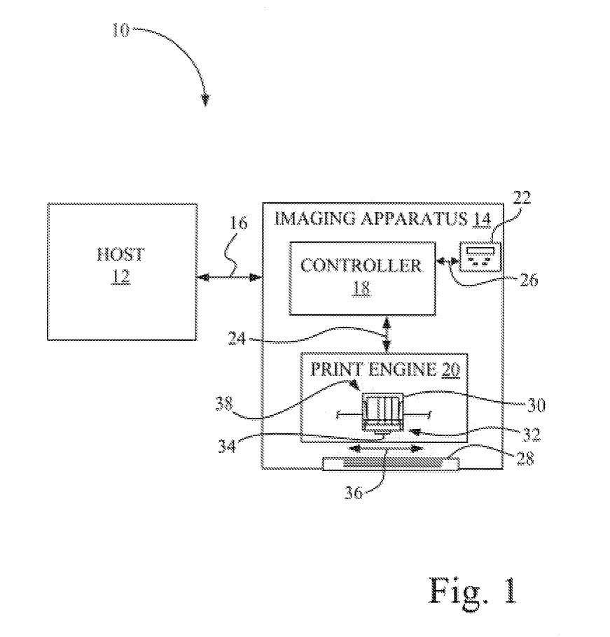

Referring to FIG. 1, there is shown a diagrammatic depiction of an imaging system 10 in accordance with an embodiment of the present invention. Imaging system 10 may include a host 12 and an imaging apparatus 14. Imaging apparatus 14 communicates with host 12 via a communications link 16. Communications link 16 may be established by a direct cable connection, wireless connection or by a network connection such as for example an Ethernet local area network (LAN).

Alternatively, imaging apparatus 14 may be a standalone unit that is not communicatively linked to a host, such as host 12. For example, imaging apparatus 14 may take the form of an all-in-one, i.e., multifunction, machine that includes standalone copying and facsimile capabilities, in addition to optionally serving as a printer when attached to a host, such as host 12.

Host 12 may be, for example, a personal computer including an input/output (I/O) device, such as keyboard and display monitor. Host 12 further includes a processor, input/output (I/O) interfaces, memory, such as RAM, ROM, NVRAM, and a mass data storage device, such as a hard drive, CD-ROM and/or DVD units. During operation, host 12 may include in its memory a software program including program instructions that function as an imaging driver, e.g., printer driver software, for imaging apparatus 14. Alternatively, the imaging driver may be incorporated, in whole or in part, in imaging apparatus 14.

In the embodiment of FIG. 1, imaging apparatus 14 includes a controller 18, a print engine 20 and a user interface 22.

Controller 18 includes a processor unit and associated memory, and may be formed as an Application Specific Integrated Circuit (ASIC). Controller 18 communicates with print engine 20 via a communications link 24. Controller 18 communicates with user interface 22 via a communications link 26. Communications links 24 and 26 may be established, for example, by using standard electrical cabling or bus structures, or by wireless connection.

Print engine 20 may be, for example, an ink jet print engine configured for forming an image on a sheet of print media 28, such as a sheet of paper, transparency or fabric.

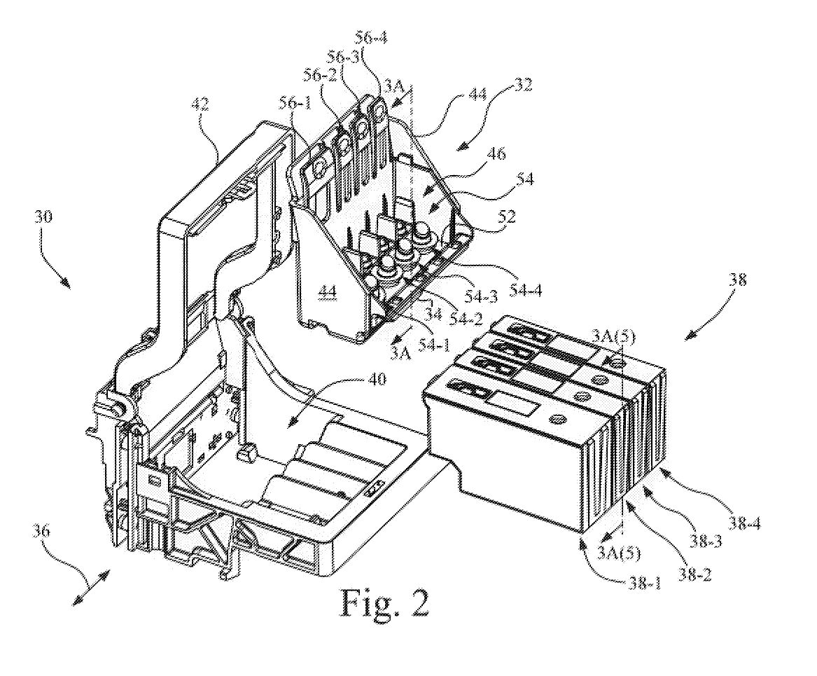

Print engine 20 may include, for example, a reciprocating printhead carrier 30. Referring also to FIG. 2, printhead carrier 30 is mechanically and electrically configured to mount and carry at least one printhead assembly 32 that includes at least one ink jet micro-fluid ejection device 34. Printhead carrier 30 transports printhead assembly 32, and in turn ink jet micro-fluid ejection device 34, in a reciprocating manner in a bi-directional main scan direction, i.e., axis, 36 over an image surface of the sheet of print media 28 during a printing operation.

Printhead assembly 32 is configured to mount and carry a plurality of removable ink tanks 38, and to facilitate an ink transfer from one or more of the plurality of ink tanks 38 to micro-fluid ejection device 34. The plurality of ink tanks 38 are individually identified as ink tanks 38-1, 38-2, 38-3 and 38-4, and may include a monochrome ink tank containing black ink, and three color ink tanks containing cyan, magenta, and yellow inks. Micro-fluid ejection device 34 may include an ink jet nozzle array for each color of ink.

FIG. 2 shows in a perspective view printhead carrier 30, and printhead assembly 32 and the plurality of ink tanks 38 in an uninstalled state. Printhead assembly 32 is mounted into position to printhead carrier 30 by inserting printhead assembly 32 into a cavity 40 in printhead carrier 30, and is latched in position by a mounting lever 42. Each of the ink tanks 38-1, 38-2, 38-3 and 38-4 is respectively mounted to printhead assembly 32, as will be discussed in more detail below.

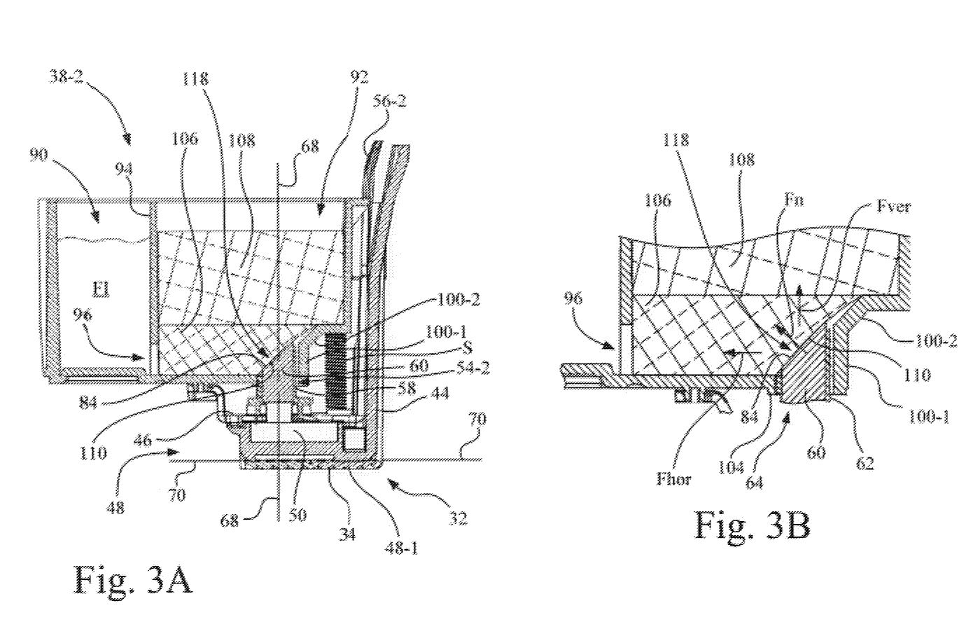

Referring also to FIG. 3A, printhead assembly 32 includes a printhead body 44 and a filter cap 46. Micro-fluid ejection device 34 is attached to snout portion 48 of printhead body 44, and more particularly, to a base surface 48-1 of snout portion 48 of printhead body 44. As can be best seen in FIG. 3A, printhead body 44 is configured to define individual filtered ink/air reservoirs 50 (only one shown) that are in fluid communication with micro-fluid ejection device 34. Filter cap 46 is attached to printhead body 44 via a hermetic seal, such as by welding or adhesive attachment. Each filtered ink/air reservoir 50 is located in a region between filter cap 46 and micro-fluid ejection device 34. Each filtered ink/air reservoir 50, for example, stores air that is ingested during printing.

Referring also to FIG. 2, filter cap 46 has a filter cap body 52 configured with a plurality of ink receiving devices 54, individually identified as ink receiving device 54-1, ink receiving device 54-2, ink receiving device 54-3, and ink receiving device 54-4 that operably engages and facilitates fluid communication with the respective ink output ports of ink tanks 38-1, 38-2, 38-3 and 38-4, respectively. Ink tanks 38-1, 38-2, 38-3 and 38-4 are individually mounted to printhead assembly 32 via individual latches 56-1, 56-2, 56-3 and 56-4. A spring S is provided to assist the removal of each of ink tanks 38 when the respective latch 56-1, 56-2, 56-3 and 56-4 is released.

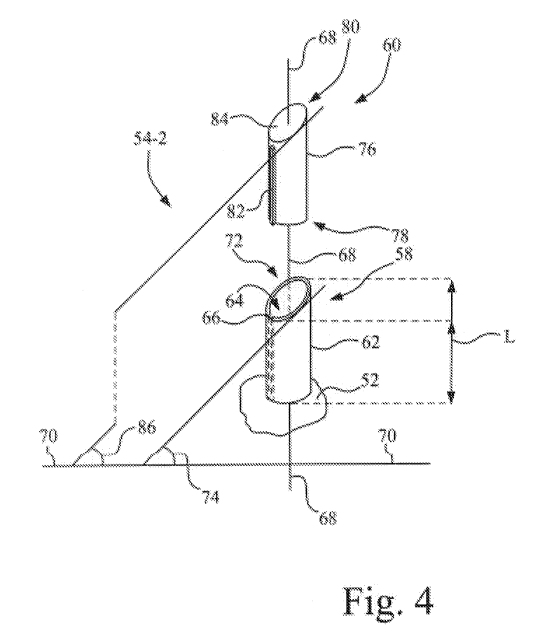

FIG. 4 is an exploded enlarged perspective view of one of the ink receiving devices 54, using ink receiving device 54-2 as an example. Each of ink receiving devices 54 are similar in design, varying only in size in the present embodiment. Accordingly, for convenience and ease of discussion, the following description will specifically reference ink receiving device 54-2, but those skilled in the art will recognize that the description may be applied equally to each of ink receiving device 54-1, ink receiving device 54-3, and ink receiving device 54-4.

Referring now also to FIG. 3A, ink receiving device 54-2 includes a wick retainer 58 and a wick 60. Wick retainer 58 is coupled to printhead body 44 via filter cap body 52.

Wick retainer 58 includes a side wall 62 that defines an opening 64 in fluid communication with micro-fluid ejection device 34. An elongate interior channel 66 is formed in side wall 62.

In one embodiment, for example, wick retainer 58 may be formed as a cylinder having an axis 68 extending in a direction perpendicular to a plane 70 of base surface 48-1 of snout portion 48, wherein the cylinder is of non-uniform length L to define a distal end 72 of the cylinder that is formed at an acute angle 74 with respect to plane 70 of base surface 48-1. In this embodiment, opening 64 is substantially circular at the intersection of wick retainer 58 and filter cap body 52, but has an elliptical shape along the perimeter of distal end 72.

Wick 60 has a porous elongate body 76 having a proximal end 78, a distal end 80, and an elongate side rib 82. Proximal end 78 is inserted into opening 64 of wick retainer 58, and distal end 80 projects outwardly from distal end 72 of wick retainer 58, with the majority of porous elongate body 76 being contained within wick retainer 58. In one embodiment, for example, distal end 80 may project outwardly from distal end 72 of wick retainer 58 by a distance of about 0.1 to 3 millimeters. Porous elongate body 76 may be formed, for example, from a porous felt or porous foam material.

During insertion of porous elongate body 76 into opening 65 of wick retainer 58, elongate side rib 82 is slidably engaged with elongate interior channel 66 of wick retainer 58. The engagement of elongate side rib 82 with elongate interior channel 66 maintains the desired axial orientation of wick 60 with respect to wick retainer 58 about axis 68.

Distal end 80 of wick 60 has a porous ink receiving surface 84. Porous ink receiving surface is oriented at an acute angle 86 with respect to plane 70 of base surface 48-1 of snout portion 48 of printhead body 44. In one embodiment, for example, acute angle 86 may be from 30 to 60 degrees, and angle 86 may be selected to be equal to, or substantially equal to, angle 74, or vice-versa.

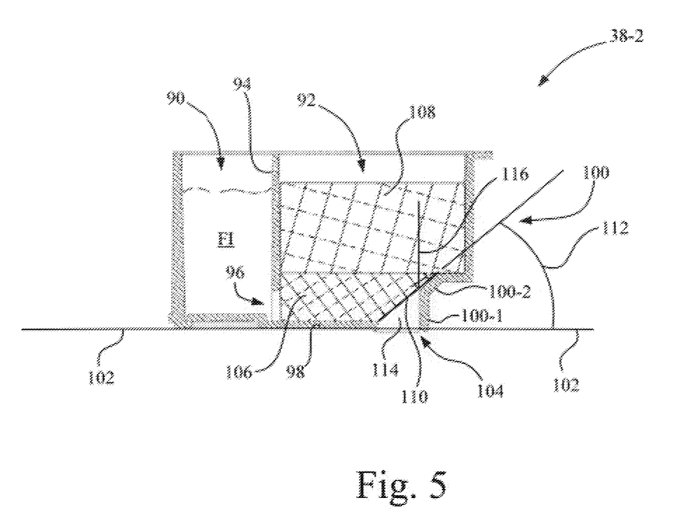

FIG. 5 is an enlarged side sectional view of one of the ink tanks 38, using ink tank 38-2 as an example. Each of ink tanks 38 are similar in design, varying only in size in the present embodiment. Accordingly, for convenience and ease of discussion, the following description will specifically reference ink tank 38-2, but those skilled in the art will recognize that the description may be applied equally to each of ink tank 38-1, ink tank 38-3, and ink tank 38-4.

Ink tank 38-2 includes a free ink chamber 90 and a suspended ink chamber 92. Free ink chamber 90 includes a free-flowing supply of ink FI, and is positioned adjacent to suspended ink chamber 92. Free ink chamber 90 is separated from suspended ink chamber 92 by a dividing wall 94. Dividing wall 94 has an ink communication port 96 to provide fluid communication between free ink chamber 90 and suspended ink chamber 92.

Suspended ink chamber 92 has a base 98, and a plurality of side walls 100 extending upwardly away from base 98. The plurality of side walls include, for example, a first side wall portion 100-1 and a beveled side wall portion 100-2 extending upwardly and outwardly from first side wall portion 100-1. Base 98 is located along a first plane 102. Suspended ink chamber 92 has an ink output port 104 formed through base 98.

Positioned in suspended ink chamber 92 adjacent to base 98 is a lower ink suspension body 106. An upper ink suspension body 108 is positioned in suspended ink chamber 92 adjacent to and above lower ink suspension body 106. Each of lower ink suspension body 106 and upper ink suspension body 108 may be constructed from a porous material, such as for example, from a porous felt material or a porous foam material.

Lower ink suspension body 106 has a porous ink transfer surface 110 positioned above ink output port ink output port 104. Porous ink transfer surface 110 is oriented at an acute angle 112 with respect to first plane 102 of base 98. Porous ink transfer surface 110 extends from base 98 to engage first side wall portion 100-1 to define a wedge-shaped void 114 located above ink output port 104. In one embodiment, for example, first side wall portion 100-1 is oriented along a second plane 116 that intersects porous ink transfer surface 110 at a location separated from ink output port 104, such that first side wall portion 100-1 and porous ink transfer surface 110 combine to define wedge-shaped void 114. In this embodiment, second plane 116 is substantially perpendicular to first plane 102. Also, porous ink transfer surface 110 of lower ink suspension body 106 is positioned to contact beveled side wall 100-2 along its surface.

Referring again to FIGS. 3A and 3B, tank 38-2 is shown installed on printhead assembly 32. As shown, an ink tank interface 118 is formed between printhead assembly 32 and ink tank 38-2. In the present embodiment, ink tank interface 118 is formed by engagement of two angled porous surfaces 84, 110 oriented angularly with respect to the direction of ink flow to the ink output port 104, and in the orientation as shown in FIG. 3A is in a direction parallel to, then toward, plane 70. More particularly, ink tank interface 118 is formed by the engagement of porous ink receiving surface 84 of wick 60 with porous ink transfer surface 110 of lower ink suspension body 106. Each of the two angled porous surfaces 84, 110 are substantially parallel upon engagement. In one embodiment, for example, the angle of ink tank interface 118 formed at the intersection of porous ink receiving surface 84 of wick 60 and porous ink transfer surface 110 of lower ink suspension body 106 may be in the range of 30 to 60 degrees from the direction of ink flow, e.g., parallel to plane 70, which in the orientations of the drawings of FIGS. 3A and 4 is shown as being horizontal.

The enlarged cross-section of FIG. 3B shows forces involved in the engagement of the angled porous ink receiving surface 84 of wick 60 with the angled porous ink transfer surface 110 of lower ink suspension body 106. Wick retainer 58 is extended and angled to correspond to that of wick 60 so as to provide adequate support of wick 60, which must sustain some of the horizontal forces Fhor.

The advantage of the angled interface surfaces 84, 110 of ink tank interface 118 is that the vertical insertion/latching force is reduced over the prior art. For a given normal force Fn, the vertical force Fver will be equal the insertion/latching force. Vertical force Fver in conjunction with horizontal force Fhor reduces the tendency for the lower ink suspension body 106 to lift or deform upwards from base 98, thereby reducing the possibility of getting unwanted air paths to ink output port 104, and in turn, to micro-fluid ejection device 34. Also, the horizontal force Fhor is now directed so as to bias lower ink suspension body 106 toward ink communication port 96 to the free ink FI in free ink chamber 90, further reducing the likelihood of getting unwanted air paths to ink output port 104.

The wick 60 and its contact with lower ink suspension body 106 is a resistance to liquid flow to ink output port 104 and to micro-fluid ejection device 34. In striving for a compact design, wick 60 is designed to be small in size, but this causes the resistance (pressure drop) to become significant. By having porous ink receiving surface 84 of wick 60 cut at an angle 86, the contact area with lower ink suspension body 106 is enlarged for a given wick diameter. Thus, a lower possible fluid resistance and increased reliability of the fluid interface may be achieved.

While this invention has been described with respect to embodiments of the invention, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. An imaging apparatus, comprising:
a printhead carrier configured for reciprocating motion along a main scan axis;
a printhead assembly mounted to said printhead carrier;
an ink tank mounted to said printhead assembly; and
an ink tank interface formed between said printhead assembly and said ink tank, said ink tank interface being formed by engagement of two angled porous surfaces oriented angularly with respect to a direction of ink flow.

2. The imaging apparatus of claim 1, wherein each of said two angled porous surfaces are substantially parallel upon engagement.

3. The imaging apparatus of claim 1, said printhead assembly comprising:
a printhead body mounted to said printhead carrier, said printhead body having a snout portion forming a base surface;
a micro-fluid ejection device attached to said base surface of said snout portion;
a wick retainer coupled to said printhead body and defining an opening in fluid communication with said micro-fluid ejection device; and
a wick forming one of said two angled porous surfaces of said ink tank interface, said wick having a proximal end and a distal end, said proximal end being inserted into said opening of said wick retainer and said distal end projecting outwardly from said wick retainer, said distal end of said wick having a porous ink receiving surface, said porous ink receiving surface being oriented at an acute angle with respect to a plane of said base surface.

4. The imaging apparatus of claim 3, wherein:
said wick retainer has a side wall defining said opening, with an elongate interior channel formed in said side wall, and
said wick is a porous elongate body having an elongate side rib that slidably engages said elongate interior channel of said wick retainer when said wick is inserted into said opening of said wick retainer.

5. The imaging apparatus of claim 3, wherein said wick retainer is formed as a cylinder having an axis extending in a direction perpendicular to said plane of said base surface, wherein said cylinder is of non-uniform length to define a distal end of said cylinder that is formed at an acute angle with respect to said plane of said base surface.

6. The imaging apparatus of claim 1, said ink tank comprising:
an ink chamber having a base, and a plurality of side walls extending away from said base, said base being located along a first plane, said ink chamber having an ink output port formed through said base;
an ink suspension body forming one of said two angled porous surfaces of said ink tank interface, said ink suspension body being positioned in said ink chamber adjacent to said base, said first ink suspension body having a porous ink transfer surface positioned above said ink output port, said porous ink transfer surface being oriented at an acute angle with respect to said first plane of said base.

7. The imaging apparatus of claim 6, wherein said plurality of side walls includes a first side wall portion, said porous ink transfer surface of said ink suspension body extending from said base to engage said first side wall portion to define a wedge-shaped void located above said ink output port.

8. The imaging apparatus of claim 7, wherein said plurality of side walls includes a beveled side wall portion extending outwardly from said first side wall portion, said porous ink transfer surface of said ink suspension body being positioned to contact said beveled side wall.

9. The imaging apparatus of claim 6, wherein said plurality of side walls includes a first side wall portion oriented along a second plane that intersects said porous ink transfer surface of said ink suspension body at a location separated from said ink output port, said first side wall portion and said porous ink transfer surface of said ink suspension body combining to define a wedge-shaped void located above said ink output port.

10. The imaging apparatus of claim 9, wherein said second plane is substantially perpendicular to said first plane.

11. A removable ink tank configured to be mounted to a printhead assembly installed on an imaging apparatus, comprising:
a suspended ink chamber having a base, and a plurality of side walls extending away from said base, said base being located along a first plane, said ink chamber having an ink output port formed through said base;
a first ink suspension body positioned in said suspended ink chamber adjacent to said base, said first ink suspension body having a porous ink transfer surface positioned above said ink output port, said porous ink transfer surface being oriented at an acute angle with respect to said first plane of said base.

12. The removable ink tank of claim 11, wherein said plurality of side walls includes a first side wall portion, said porous ink transfer surface of said first ink suspension body extending from said base to engage said first side wall portion to define a wedge-shaped void located above said ink output port.

13. The removable ink tank of claim 12, wherein said plurality of side walls includes a beveled side wall portion extending outwardly from said first side wall portion, said porous ink transfer surface of said first ink suspension body being positioned to contact said beveled side wall.

14. The removable ink tank of claim 11, wherein said plurality of side walls includes a first side wall portion oriented along a second plane that intersects said porous ink transfer surface of said first ink suspension body at a location separated from said ink output port, said first side wall portion and said porous ink transfer surface of said first ink suspension body combining to define a wedge-shaped void located above said ink output port.

15. The removable ink tank of claim 14, wherein said second plane is substantially perpendicular to said first plane.

16. The removable ink tank of claim 11, wherein said porous transfer surface is oriented at an angle between 30 degrees and 60 degrees with respect to said first plane.

17. The removable ink tank of claim 11, further comprising a second ink suspension body positioned in said suspended ink chamber adjacent to and above said first ink suspension body.

18. The removable ink tank of claim 17, wherein each of said first ink suspension body and said second ink suspension body is a constructed from one of a porous felt material or a porous foam material.

19. A printhead assembly configured to be mounted to a printhead carrier of an imaging apparatus, comprising:
a printhead body having a snout portion forming a base surface;
a micro-fluid ejection device attached to said base surface of said snout portion;
a wick retainer coupled to said printhead body and defining an opening in fluid communication with said micro-fluid ejection device; and
a wick having a proximal end and a distal end, said proximal end being inserted into said opening of said wick retainer and said distal end projecting outwardly from said wick retainer, said distal end of said wick having a porous ink receiving surface, said porous ink receiving surface being oriented at an acute angle with respect to a plane of said base surface.

20. The printhead assembly of claim 19, wherein:
said wick retainer has a side wall defining said opening, with an elongate interior channel formed in said side wall, and
said wick is a porous elongate body having an elongate side rib that slidably engages said elongate interior channel of said wick retainer when said wick is inserted into said opening of said wick retainer.

21. The printhead assembly of claim 19, wherein said wick retainer is formed as a cylinder having an axis extending in a direction perpendicular to said plane of said base surface, wherein said cylinder is of non-uniform length to define a distal end of said cylinder that is formed at an acute angle with respect to said plane of said base surface.
